(19) United States
(12) Patent Application Publication
(10) Pub. No.: US 2012/0008554 A1
(43) Pub. Date: Jan. 12, 2012

(54) LOCAL PDN ACCESS METHOD IN WIRELESS COMMUNICATION SYSTEM

(75) Inventors: Dae Joong Kim, Gyeonggi-do (KR); Ji Cheol Lee, Gyeonggi-Do Yongin-Si (KR); Hyun Gil Ko, Seoul (KR); Chae Gwon Lim, Seoul (KR); Eun Hui Bae, Seoul (KR)

(73) Assignee: SAMSUNG ELECTRONICS CO., LTD., Suwon-city, Gyeonggi-do (KR)

(21) Appl. No.: 13/143,590

(22) PCT Filed: Jan. 7, 2010
(86) PCT No.: PCT/KR10/00111

§ 371 Date: Sep. 23, 2011

(30) Foreign Application Priority Data
Jan. 8, 2009 (KR) 10-2009-0001561

(51) Int. Cl. H04W 48/18

(52) U.S. Cl. 370/328

(57) ABSTRACT

A local Packet Data Network (PDN) access method of a User Equipment (UE) in a wireless communication system is provided. The local Packet Data Network (PDN) access method in a wireless communication system according to the present invention includes transmitting a local PDN connectivity request message from a base station to a Mobility Management Entity (MME); transmitting a bearer request message from the MME received the PDN connectivity request message to a Serving Gateway (SGW) proxy of the base station; forwarding the bearer request message from the SGW proxy to a PDN Gateway (PGW) proxy of the base station; transmitting a bearer response message indicating a local PDN access service of the base station in gateway mode from the PGW proxy to the SGW proxy; forwarding the bearer response message from the SGW to the MME; transmitting a bearer setup message from the MME received the bearer response message to the base station; and connecting a mobile terminal to the local PDN based on information contained in the bearer setup message.

### TECHNICAL FIELD

The present invention relates to wireless communications and, in particular, to a local Packet Data Network (PDN) access method of a User Equipment (UE) in a wireless communication system.

### BACKGROUND ART

The 3^{rd} Generation Partnership Project (3GPP) standard does not specify a method for a UE to directly access a local PDN such as a home network and an enterprise network but via backhaul networks, i.e. Virtual Private network (VPN) service, provided by a commercial network service provider.

FIG. 1 is a diagram illustrating a conventional system in which a UE attached to a wireless communication system accesses a local PDN. In FIG. 1, a PDN Gateway (PGW) 109 of an evolved packet core network and a local PDN 115 are connected through the tunnel established by means of a Layer 2 Tunneling Protocol (L2TP), a Point-to-Point Tunneling Protocol (PPTP), or an Internet Security (IPsec) protocol.

Referring to FIG. 1, the UE 101 sends a PDN Connectivity Request message to an evolved Node B (eNB) 103 to access a the local PDN 115, and the eNB 103 forwards the PDN Connectivity Request message to a Mobility Management Entity (MME) 105. If the PDN Connectivity Request message is received, the MME 105 determines a PGW 109 for the connection of the UE 101 base on the Access Point Name (APN) contained in the PDN Connectivity Request message and the subscriber profile acquired from a Home Subscriber Server (HSS). The PGW 109 establishes a VPN connection with a designated VPN server for the UE 101 and routes packets between the UE 101 and the VPN server.

In the conventional connection establishment message as shown in FIG. 1, the connection to the local PDN 115 through the VPN service provided by the PGW 109 is inefficient to process data traffic and costly to implement.

In the system architecture of FIG. 1, even when the local PDN 115 and the eNB 103 are connected to the same Local Area Network (LAN) and the UE 101 located in the service coverage of the eNB 103, the packet data are delivered through a long routing path. That is, when the UE 101 is attempting to access the PDN 115, all the packet data transmitted by the UE 101 have to be delivered to the Core Network of the operator's network via a backhaul network, and the packet data processed by the PGW 109 is delivered to the local PDN 115 via the Internet and the Internet Service Provider (ISP) network 113. Since the most home and enterprise networks uses the ISP network as a backhaul network, the packet data are passing the backhaul network twice, thereby increasing unnecessary network traffic and routing delay. That is, the conventional routing method routes the potential local packet data through the core network, thereby requiring high bandwidth backhaul network. This causes increase of operating expenditure of both the service provider and enterprise or home network operator. Also, the increased data traffic requires extension of the core network.

### DISCLOSURE OF INVENTION

### Technical Problem

In the above-described conventional local PDN access method, the local PDN must be connected to the Internet in order for the UE to access the local PDN. However, the local PDN may not be connected to the Internet but the eNB 103 for a certain reason, e.g. physical difficulty of wire connection to the Internet, failure of securing a public IP address in terms of financial capability, and isolation of the local PDN from the public Internet in terms of security. With such standalone local PDN, the conventional local PDN access method is useless.

### Solution to Problem

In order to solve the above problems of prior arts, the present invention provides a local PDN access method of a UE that is capable of improving routing efficiency of data traffic by routing the local data traffic without involvement of the core network.

Also, the present invention provides a local PDN access method of a UE that is capable of supporting mobility of the UE by connecting multiple ENBs to the local PDN.

Also, the present invention provides a local PDN access method that is capable of facilitating local PDN access of a remote UE.

Also, the present invention provides a local PDN access method of a UE that enables a remote UE to access a standalone local PDN via a cellular communication network.

In accordance with an exemplary embodiment of the present invention, a local Packet Data Network (PDN) access method in a wireless communication system includes transmitting a local PDN connectivity request message from a base station to a Mobility Management Entity (MME); transmitting a bearer request message from the MME received the PDN connectivity request message to a Serving Gateway (SGW) proxy of the base station; forwarding the bearer request message from the SGW proxy to a PDN Gateway (PGW) proxy of the base station; transmitting a bearer response message indicating a local PDN access service of the base station in gateway mode from the PGW proxy to the SGW proxy; forwarding the bearer response message from the SGW to the MME; transmitting a bearer setup message from the MME received the bearer response message to the base station; and connecting a mobile terminal to the local PDN based on information contained in the bearer setup message.

In accordance with another exemplary embodiment of the present invention, a local Packet Data Network (PDN) access method in a wireless communication system includes transmitting a local PDN connectivity request message from a base station to a Mobility Management Entity (MME); transmitting a bearer request message from the MME received the PDN connectivity request message to a Serving Gateway (SGW) proxy of the base station; forwarding the bearer request message from the SGW proxy to a PDN Gateway (PGW) of the local PDN; transmitting a bearer response message permitting an access to the local PDN from the PGW to the SGW proxy in response to the bearer request message; forwarding the bearer response message from the SGW proxy to the MME; transmitting a bearer setup message from the MME received the bearer response message to the base station; and connecting a mobile terminal to the to the local PDN base on information contained in the bearer setup message.

In accordance with another exemplary embodiment of the present invention, a base station of a wireless communication system supporting a local Packet Data Network (PDN) access service for delivering a packet call of a mobile terminal includes a terminal interface module which provides an interface with the mobile terminal; a Serving Gateway (SGW) proxy which emulates a gateway function of a SGW and processes an S11 interface with a Mobility Management Entity (MME); a PDN Gateway (PGW) proxy which allocates an Internet Protocol (IP) address for the mobile terminal to access the local PDN and emulates a gateway function of a PGW; a General Packet Radio Service Tunneling Protocol (GTP) module which provides a S1 interface between the base station and the SGW and a packet interface between the base station and the PDN and forwards a packet call of the mobile terminal directly in gateway mode; an IP routing module which routes the packet call forwarded by the GTP module to the local PDN; and a base station controller which analyzes a message transmitted by the MME and controls routing the packet call to the local PDN based on the analysis result in gateway mode.

In accordance with still another exemplary embodiment of the present invention, a wireless communication system supporting a local Packet Data Network (PDN) access of a mobile terminal includes a local PDN including a PDN Gateway (PGW); and a base station which establishes a packet call of a mobile terminal with the local PDN, wherein the base station includes a terminal interface module which provides an interface with the mobile terminal; a Serving Gateway (SGW) proxy which emulates a gateway function of a SGW and processes an S11 interface with a Mobility Management Entity (MME); a PDN Gateway (PGW) proxy which allocates an Internet Protocol (IP) address for the mobile terminal to access the local PDN and emulates a gateway function of a PGW; a General Packet Radio Service Tunneling Protocol (GTP) module which provides a S1 interface between the base station and the SGW and a packet interface between the base station and the PDN and forwards a packet call of the mobile terminal directly in gateway mode; an IP routing module which routes the packet call forwarded by the GTP module to the local PDN; and a base station controller which analyzes a message transmitted by the MME and controls routing the packet call to the local PDN based on the analysis result in gateway mode.

### Advantageous Effects of Invention

The local PDN access method of the present invention is capable of reducing the use of the costly backhaul network and traffic load of the core network. Since the local traffic occupies large portion of the entire network traffic, the direct connection of the base station to the local PDN can reduce the traffic load of the core network significantly and routing delay of the local traffic, resulting in improvement of the service quality.

Also, the local PDN access method of the present invention is capable of routing the local traffic at private base station level, resulting in reduction of communication costs. With the reduction of the communication costs, the local PDN access method of the present invention promotes the use of the data service.

Also, the local PDN access method of the present invention is advantageous to introduce new business models from the view point of the service providers. For instance, the WiFi networks as the dominant enterprise networks can be substituted by the PDN networks of the LTE system. In this case, the members of the enterprise can access the PDN in and out of the network in the same manner. The members can access the enterprise server by means of a single mobile terminal such as a laptop anywhere and maintain the connections among the members always, resulting in improvement of productivity. Also, the PDN access method of the present invention can be applied for interconnection between the femto base station and indoor network. In this case, the user can cheaply connect the desktop computer and mobile devices with each other and access the desktop computer to upload and download data even on a travel.

### BRIEF DESCRIPTION OF DRAWINGS

The above and other objects, features and advantages of the present invention will be more apparent from the following detailed description in conjunction with the accompanying drawings, in which:

FIG. 1 is a diagram illustrating a conventional system in which a UE attached to a wireless communication system accesses a local PDN;

FIG. 2 is a diagram illustrating an architecture of a wireless communication system for supporting a local PDN access method according to an exemplary embodiment of the present invention;

FIG. 3 is a diagram illustrating an architecture of a wireless communication system for supporting a local PDN access method according to another exemplary embodiment of the present invention;

FIG. 4 is a block diagram illustrating a configuration of an eNB for supporting the local PDN access method in the wireless communication system of FIG. 2;

FIG. 5 is a block diagram illustrating a configuration of an eNB for supporting the local PDN access method in the wireless communication of FIG. 3;

FIG. 6 is a sequence diagram illustrating operations of a UE, an eNB, and an MME in a wireless communication system of which the eNB operates in gateway mode according to an exemplary embodiment of the present invention;

FIG. 7 is a sequence diagram illustrating operations of a UE, and eNB, and MME in a wireless communication system of which eNB operates in proxy mode according to an exemplary embodiment of the present invention;

FIG. 8 is a flowchart illustrating a procedure for processing an uplink data packet in a local PDN access method according to an exemplary embodiment of the present invention; and

FIG. 9 is a flowchart illustrating a procedure for processing a downlink data packet in a local PDN access method according to an exemplary embodiment of the present invention.

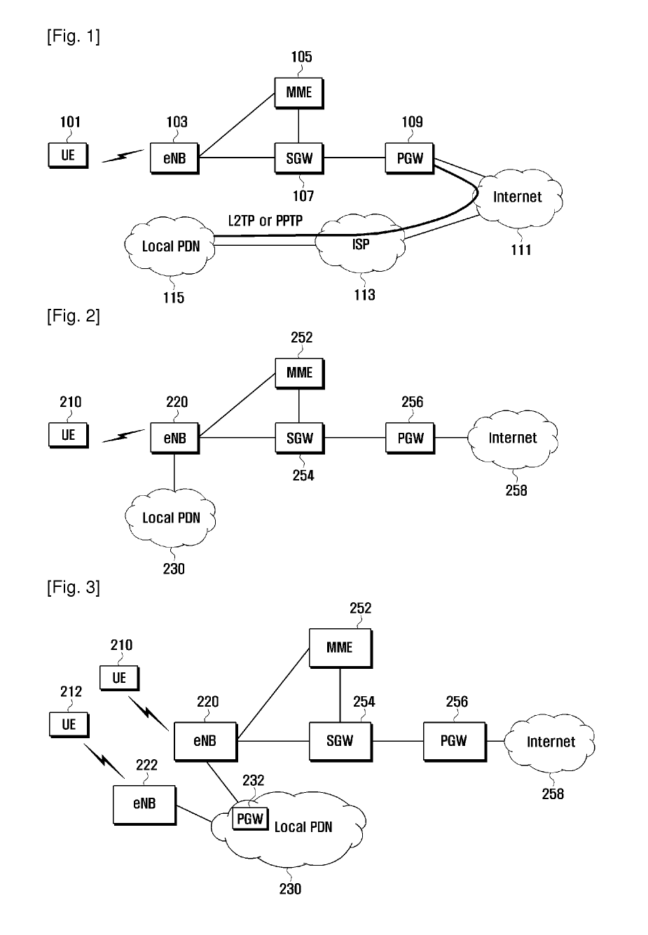

### MODE FOR THE INVENTION

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

The present invention proposes a method for a 3GPP UE to access a local Packet Data Network (PDN). In an exemplary embodiment of the present invention, the local PDN is a private network connected to the 3GPP eNB directly and can be a home network or an enterprise network.

In the current 3GPP mobile communication standard, any method of direction connection between a local PDN and an eNB is not specified but via an access network, core network, and service application network that are operating on all IP network platform. As the use and demand of femtocell and enterprise indoor base stations increase, there is a need for a method to process the local data traffic efficiently. With the direction connection of the cellular base station to local PDN such as home and enterprise networks, it is possible to facilitate the use of the local network and reduce the use of the costly backhaul network service.

The direction connection of the private base station to a PDN must be implemented in consideration of the minimization of the influence to the current cellular network structure and service provision system while securing uniform accessibility of the UE to the core network and the local PDN. Also, it should be guaranteed for the UE to access the local PDN remotely even when it is connected to a base station which is not connected to the PDN directly. In order to achieve these requirements, the present invention is focused on the interconnection between a local PDN and a base station and the local PDN access of the UE.

FIG. 2 is a diagram illustrating an architecture of a wireless communication system for supporting a local PDN access method according to an exemplary embodiment of the present invention.

As shown in FIG. 2, the wireless communication system includes an eNB 220, an MME 252, a Serving Gateway (SGW) 254, and a PGW 256. It is noted that the PGW 256 is connected to the Internet 258 and the eNB 220 is connected to the local PDN 230 directly. In this network architecture, if the UE 210 requests for the access to the local PDN 230, the eNB 220 routes the local data traffic to the local PDN 230 rather than to the core network (i.e. MME 252, SGW 254, and PGW 256), thereby processing the local data traffic efficiently.

FIG. 3 is a diagram illustrating an architecture of a wireless communication system for supporting a local PDN access method according to another exemplary embodiment of the present invention.

The wireless communication system of FIG. 3 is identical with that of FIG. 2 except that multiple eNBs 220 and 222 are connected to the local PDN 230 via a PGW 232 such that the UEs 210 and 212 can access the local PDN 230 remotely. With the connection of the local PDN 230 to multiple eNBs 220 and 222, the wireless communication system can support the UEs' mobility.

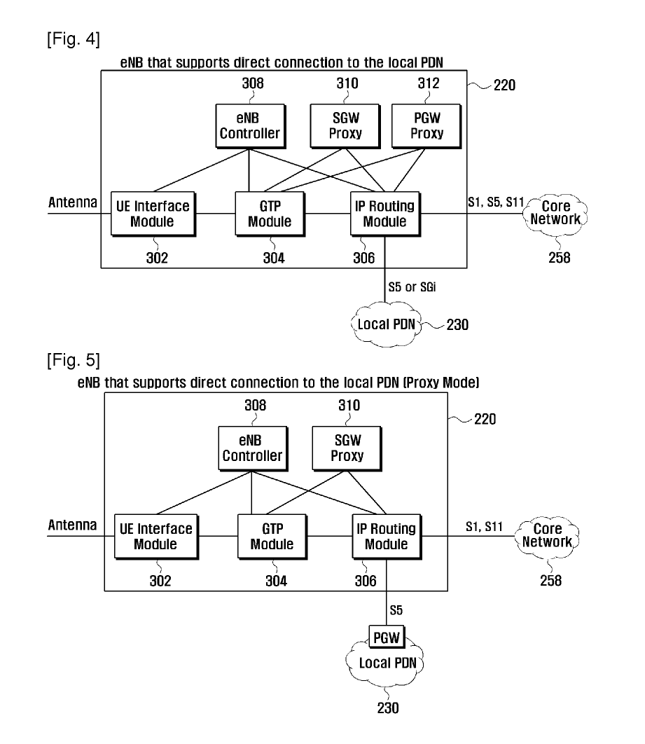

FIG. 4 is a block diagram illustrating a configuration of an eNB for supporting the local PDN access method in the wireless communication system of FIG. 2.

Referring to FIG. 4, the eNB 220 includes an SGW proxy 310 which is responsible for the functions of the SGW, a PGW proxy 312 which is responsible for the functions of the PGW, a GPRS Tunneling Protocol (GTP) module 304 for processing packet data, an IP routing module 306. Also, the eNB 220 includes a UE interface module 302 and an eNB controller 308 for performing the eNB functions specified in the standard. The eNB controller 308 is responsible for providing MME interface function, X2 interface function, and a UE Radio Resource Control (RRC) interface function specified in the 3GPP TS36.300.

The SGW proxy 310 is responsible for the proxy functions of the serving gateway specified in the 3GPP TS23.401. The SGW proxy 310 emulates the S11 interface between the SGW 254 and MME 253. The SGW proxy 310 establishes the bearer for the internal packet by means of the GTP module 304.

The PGW proxy 312 is responsible for the proxy function of the PDN gateway specified in the 3GPP TS23.401. In order to interwork with an external SGW, the PGW proxy 312 emulates the S5 interface. The PGW proxy 312 supports two operation modes: proxy mode and gateway mode. In case that multiple eNBs are connected to the same local PDN, the PGW proxy 312 of the eNB operates in proxy mode. In case that the local PDN 230 is not provided with a PGW, the PGW proxy 312 operates in gateway mode. In proxy mode, the PGW proxy 312 establishes a GTP tunnel between the eNB 220 and the PGW 232 of the local PDN 230. In gateway mode, the PGW proxy 312 of the eNB 220 is assigned an IP address for the access of the UE. If the eNB operates in gateway mode, this means that the local PDN 230 has no PGW and thus GTP tunnel is not supported.

The GTP module 304 manages an uplink table as shown in table 1 to support the S1 interface between the eNB 220 and the SGW 254 and the interface between the eNB and the local PDN 230 (gateway mode), and the interface between the eNB 220 and the private PGW 232 of the local PDN 230 (proxy mode). In case of handling a uplink data packet, the GTP is processed per radio bearer ID such that the destination field of the uplink data packet is set to the SGW address. If the destination filed is not set to the SGW address, the uplink data packet is forwarded to the IP routing module 306. In case of handling a downlink data packet, if the destination address of the downlink data packet is the address of the eNB 220, the GTP module 304 releases the GTP tunnel and forwards the downlink data packets through a channel identified by a radio bearer ID related to the S1 bearer ID. In case that the IP address of the of the packet to be handled by the GTP module 304 is not the address of the eNB 220, the GTP module 304 forwards the packet through a channel identified by the radio bearer ID obtained by referencing a downlink table as shown in table 2. The address of the eNB 220 may differ from the addresses used in the local PDN 230 and the core network.

TABLE 1

| Radio Bearer ID | Handling |
|---|---|
| 1 | 166.213.234.123 (SGW address at core network side) |
| 2 | DIRECT-FWD |
| 3 | DIRECT-FWD |
| 4 | 10.8.9.2 (PGW address of Local PDN) |
| 5 | 165.213.234.123 (SGW address at core network side) |

TABLE 2

| | | | EPS |
|---|---|---|---|
| Destination | Handling | RB ID | Bearer ID |
| 165.213.234.122 | GTP-STRIP- | LOOKUP | |
| (eNB address from CN's | FWD | | |
| view point) | | | |
| 10.8.9.1 | GTP-STRIP- | LOOKUP | |
| (eNB address from Local PDN's | FWD | | |
| view point) | | | |
| 10.8.9.3 | DIRECT-FWD | 2 | 101 |
| (UE address from Local PDN's | | | |
| view point) | | | |
| 10.8.9.4 | DIRECT-FWD | 3 | 102 |
| (address of eNB connected to | | | |
| local PDN) | | | |

The IP routing module 306 is responsible for the functions of a normal Layer 3 (L3) router. The IP routing module 306 supports a connection to a network including plural subnets. For instance, the IP routing module 306 can separate the Internet port connected to the Core Network and the Ethernet port connected to the local PDN.

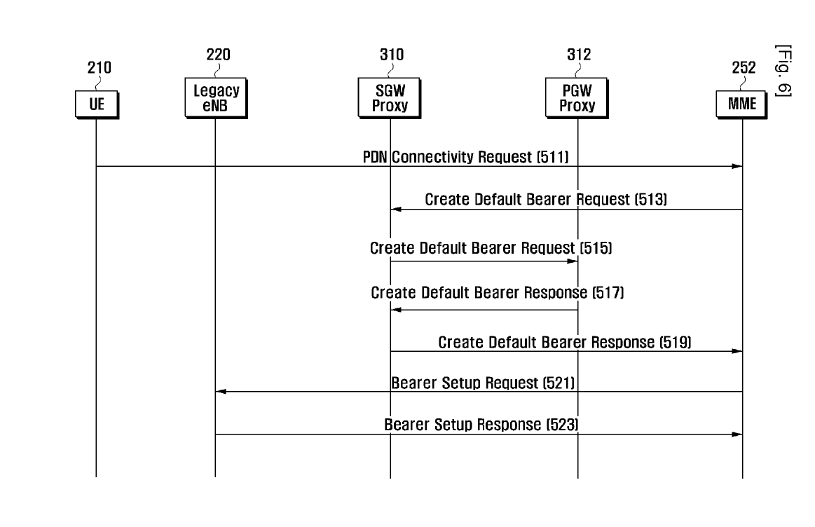

FIG. 5 is a block diagram illustrating a configuration of an eNB for supporting the local PDN access method in the wireless communication of FIG. 3. The eNB of FIG. 5 has no PGW proxy 312 depicted in FIG. 4, and the local PDN 230 is provided with a PGW 232. FIG. 5 shows the configurations of the eNB 220 and the local PDN 230 in the wireless communication system structured as shown in FIG. 3 according to an exemplary embodiment of the present invention.

The SGW proxy and PGW proxy according to an exemplary embodiment of the present invention can be applied to a private base station such as an enterprise base station or a femto base station.

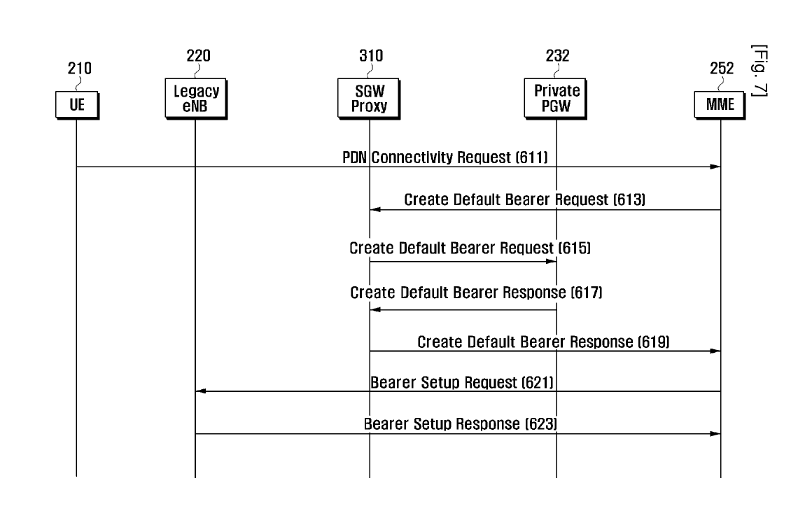

FIG. 6 is a sequence diagram illustrating operations of a UE, an eNB, and an MME in a wireless communication system of which the eNB operates in gateway mode according to an exemplary embodiment of the present invention.

Referring to FIG. 6, when the UE 210 located within the coverage of the local PDN 230 and connected to the eNB 220 is attempting to access the local PDN 230, the UE 210 sends a PDN Connectivity Request message to the eNB 220, and the eNB 220 forwards the PDN Connectivity Request message to the MME 252 (511). The PDN Connectivity Request message is defined in the 3GPP standard specification. Upon receipt of the PDN Connectivity Request message, the MME 252 selects a PGW for the connection of the UE 210 with reference to the APN contained in the PDN Connectivity Request message. In case when attempting to access PDN 230 supporting the connection of the eNB 220, the UE 210 adds the APN of the local PDN 230 to the PDN Connectivity Request message. If it is determined to establish the connection to the local PDN 230, the MME 252 sends a Create Default Bearer Request message (513). The Create Default Bearer Request message includes an EPS bearer ID field defined in the 3GPP TS29.274 specification.

If the Create Default Bearer Request message is received, the SGW proxy 310 of the eNB processes the Create Default Bearer Request message internally. That is, the MME 252 sends the Create Default Bearer Request message to the eNB in response to the PDN Connectivity Request message (513), the SGW proxy 310 of the eNB forwards the Create Default Bearer Request message to the PGW proxy 312 of the eNB (515), and the PGW proxy 312 sends a Create Default Bearer Response message to the SGW proxy 310 in response to the Create Default Bearer Request message (517). The SGW 310 sends a Create Default Bearer Response message to MME 252 (519).

Once the Create Default Bearer Response message is received, the MME 252 sends a Bearer Setup Request message to a Legacy eNB function 220 of the eNB (521). The Legacy eNB function 220 of the eNB sends a Bearer Setup Response message to the MME 252 in response to the Bearer Setup Request message (523) and establishes a connection between the UE 210 and the local PDN 230.

The operations of the eNB 220 in gateway mode (including the legacy eNB function 220, SGW proxy 310, and PGW proxy 312) and MME 252 are described hereinafter in more detail. The SGW proxy 310 of the eNB 220 operating in gateway mode forwards the Create Default Bearer Request message received from the MME 252 to the PGW proxy 312 internally at step 515. Upon receipt of the Create Default Bearer Request message, the PGW proxy 312 selects an IP address available for the PDN 230 from the downlink table as shown in table 2 and registers the IP address with the local PDN 230. Simultaneously, the PGW proxy 312 registers the value of the EPS Bearer ID contained in the Create Default Bearer Request message with the downlink table as shown in table 2. Next, the PGW proxy 312 sends the Create Default Bearer Response message to the SGW proxy 310 in response to the Create Default Bearer Request message at step 517. The Create Default Bearer Request message includes an End-User Address field set to the IP address assigned to the UE and a GTP Tunnel ID field set to 0. The Create Default Bearer Request message also includes a EPS Bearer ID field. Upon receipt of the Create Default Bearer Response message, the SGW proxy 310 transmits the Create Default Bearer Response message to the MME 252 at step 519.

If the Create Default Bearer Response message is received, then the MME 252 checks the GTP Tunnel ID field of the Create Default Bearer Response message. If the GTP Tunnel ID field of the Create Default Bearer Response message is set to 0, the MME 252 regards that the eNB 220 operates in gateway mode in which the eNB 220 establishes the connection between the UE 210 and the PDN 230 directly. In this case, the MME 252 transmits an SAE Bearer Setup Request message (defined in 3GPP TS36.413) having an EPS Bearer ID field set to 0 to the eNB 220 at step 521.

If the SAE Bearer Setup Request message is received, the eNB 220 processes the SAE Bearer Setup Request message internally by means of the eNB controller 208. The eNB controller 208 checks the EPS Bearer ID field of the SAE Bearer Setup Request message. If the EPS Bearer ID field is set to 0, the eNB controller 208 regards the packet call as a direct forward call to be delivered to the local PDN 230 directly in gateway mode. In this case, the eNB controller 208 registers the Radio Bearer ID for the corresponding packet call with the uplink table as shown in table 1 along with the handling method of DIRECT-FWD. This means that the packet incoming on the channel identified by the corresponding Radio Bearer ID is forwarded to the local PDN by means of the IP routing module 206 rather than through a GTP tunnel. The eNB controller 208 also checks the IP address of the UE 210 which is mapped to the EPC Bearer ID contained in the SAE Bearer Setup Request message by referencing the downlink table of the GTP module 304 (as shown in table 2) and writes the Radio Bearer ID in the corresponding field of the downlink table. Afterward, the eNB can make a routing decision to deliver the packet in downlink direction.

FIG. 7 is a sequence diagram illustrating operations of a UE, and eNB, and MME in a wireless communication system of which eNB operates in proxy mode according to an exemplary embodiment of the present invention.

Referring to FIG. 7, when the UE 210 located within the coverage of the local PDN 230 and connected to the eNB 220 is attempting to access the local PDN 230, the UE 210 sends a PDN Connectivity Request message to the eNB 220, and the eNB 220 forwards the PDN Connectivity Request message to the MME 252 (611). In order to access the local PDN 230 connected to the eNB 220, the UE 210 sends the PDN Connectivity Request message containing an APN of the local PDN 230. If the MME 252 determines that the connection to the local PDN 230 is required, the MME 252 transmits a Create Default Bearer Request message to the eNB 220 (613). The Create Default Bearer Request message includes an EPS Bearer ID field defined in the 3GPP TS29.274 specification.

Upon receipt of the Create Default Bearer Request message, the SGW proxy 310 of the eNB 220 forwards the Create Default Bearer Request message to the private PGW 232 of the local PDN 230 (615). If the Create Default Bearer Request message is received, the private PGW 232 of the local PDN 230 sends a Create Default Bearer Response message to SGW proxy 310 of the eNB 220 (617). Upon receipt of the Create Default Bearer Response message, the SGW proxy 310 of the eNB 220 forwards the Create Default Bearer Response message to the MME 252 (619).

If the Create Default Bearer Response message is received, the MME 252 generates a Bearer Setup Request message with reference to the information carried by the Create Default Bearer Response message and sends the Bearer Setup Request message to the legacy eNB 220 (621). Upon receipt of the Bearer Setup Request message, the eNB 220 sends a Bearer Setup Response message to the MME 252 (623) and establishes a connection between the UE 210 and the local PDN 230 to provide the service.

The operations of the eNB 220 in proxy mode (including the legacy eNB function 220 and SGW proxy 310) and the MME 252 are described hereinafter in more detail.

The SGW proxy 310 of the eNB 220 operating in proxy mode forwards the Create Default Bearer Request message received from the MME 252 to the private PGW 232 located in the local PDN 230 at step 615. At this time, the Source and Destination IP addresses of the Create Default Bearer Request message are reset to the IP address of the eNB 220 for used in the local PDN 230 and the IP address of the private PGW 232 of the local PDN 230 respectively. If the Create Default Bearer Request message is received, the private PGW 232 of the local PDN 230 allocates and IP address and generates a PGW side end of a GTP tunnel and sends a Create Default Bearer Response message containing the information on the allocated IP address and the PGW side end to the eNB 220 (617).

Upon receipt of the Create Default Bearer Response message, the SGW proxy 310 of the eNB 220 changes the source IP address and the destination IP address of the Create Default Bearer Response message to the respective eNB address and the MME address for used in the core network side and sends Create Default Bearer Response message to the MME 252 (619). Here, the Create Default Bearer Response message includes a SGW S1-U ADDRESS FOR USER PLANE field set to the value of the PGW S5/S8 ADDRESS FOR USER PLANE field received from the private PGW 232 of the local PDN 230 and a SGW S1-U TEID FOR USER PLANE field set to the value of the PGW S5/S8 TEID FOR USER PLANE field received from the private PGW 232 of the local PDN 230.

Upon receipt of the Create Default Bearer Response message, the MME 252 sends an SAE Bearer Setup Request message to the eNB 220 according to the procedure specified in the 3GPP TS36.413 (621). The SAE Bearer Setup Request message includes a Transport Layer Address field and a GTP-TEID field that are set to the respective SGW S1-U ADDRESS FOR USER PLANE field and SGW S1-U TEID FOR USER PLANE field of the Create Default Bearer Response message received from the SGW proxy server 310.

If the SAE Bearer Setup Request message is received from the MME 252, the eNB 220 processes the SAE Bearer Setup Request message by means of the eNB controller 308. The eNB controller 308 establishes a Radio Bearer and creates a table mapping the Radio Bearer ID to the EPS Bearer ID received from the MME 252 according to the procedure specified in the standard such that the GTP module 304 refers to. In this table, the Transport Layer Address contained in the SAE Bearer Setup Request message is written so as to be used as the destination address of the GTP tunnel.

The eNB 220 is set to operate in either the proxy mode or the gateway mode, but in both proxy and gateway modes.

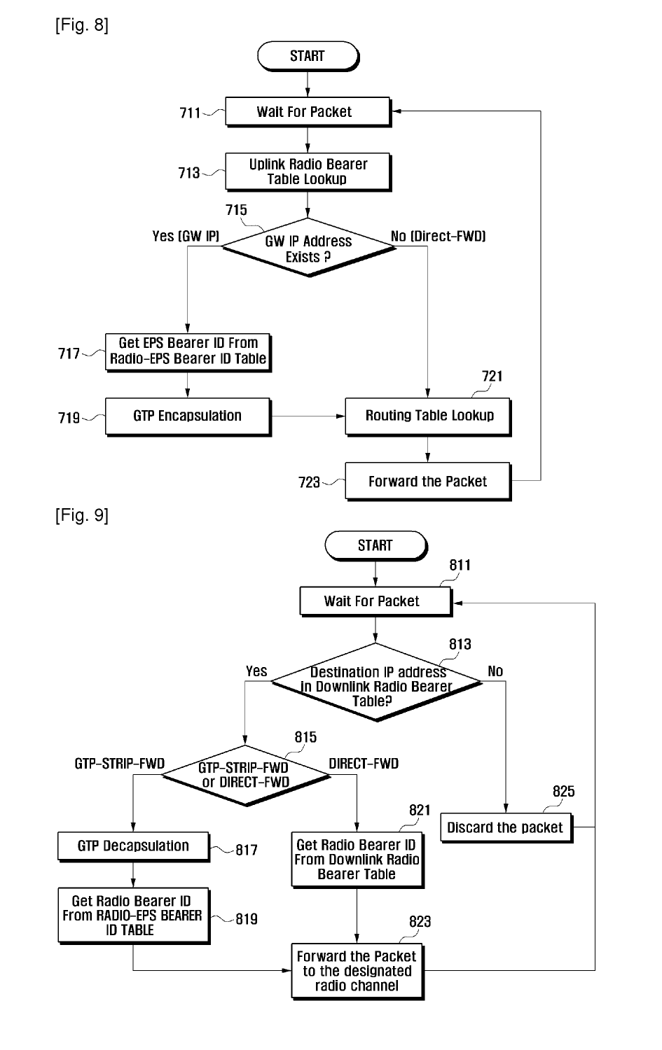

FIG. 8 is a flowchart illustrating a procedure for processing an uplink data packet in a local PDN access method according to an exemplary embodiment of the present invention. In the exemplary embodiment of FIG. 8, it is assumed an uplink data packet is received through the UE interface module 302 of the eNB 220.

Referring to FIG. 8, the eNB 220 waits for receiving an uplink data packet (711). If an uplink data packet is received through the UE interface module 302, the GTP module 304 of the eNB 220 looks up the uplink radio bearer table as shown in table 1 and checks the packet handling method for the uplink data packet (713). Next, the eNB 220 determines whether a GW IP address for the radio bearer exists in the uplink radio bearer table (715). If the Direct-FWD handling method is set for a given Radio Bearer ID, the eNB 220 forwards the uplink data packet to the IP routing module 206 directly without GTP encapsulation, and the IP routing module 306 of the eNB 220 looks up the routing table (721) and forwards the uplink data packet based on the routing table (723).

Otherwise, if an SGW IP address for the Radio Bearer ID exists in the uplink radio bearer table, the eNB 220 looks up a Radio-EPS Bearer ID table as shown in table 3 and retrieves the EPS Bearer ID mapped to the Radio Bearer ID in the Radio-EPS Bearer ID table (717) and performs GTP encapsulation on the uplink data packet with a GTP header (719). The GTP encapsulated packet is sent to the IP routing module 306, and the IP routing module 306 looks up the routing table (721) and then forwards the GTP encapsulated packet based on the routing table (723).

TABLE 3

| Radio Bearer ID | EPS Bearer ID | GW IP Address |
|---|---|---|
| 1 | 1001 | 165.213.234.123 |
| 2 | 101 | 10.8.9.2 |
| 3 | 102 | 10.8.9.2 |
| 4 | 1002 | 165.213.234.123 |

FIG. 9 is a flowchart illustrating a procedure for processing a downlink data packet in a local PDN access method according to an exemplary embodiment of the present invention.

Referring to FIG. 9, the eNB 220 waits for receiving a downlink data packet (811). The IP routing module 306 of the eNB 220 sends the GTP packet received from the SGW 254 through a GTP tunnel and the packet of which destination IP address field is set to the IP address of the UE 210 to the GTP module 304. If the downlink data packet is received, the GTP module 304 looks up the downlink radio bearer table as shown in table 2 and determines whether the destination IP address of the packet exists in the downlink radio bearer table (813). If the destination IP address of the packet does not exist in the downlink radio bearer table, this means that the packet is delivered to a wrong destination and thus the eNB 220 discards the packet (825).

Otherwise, if the destination IP address of the packet exists in the downlink radio bearer table, the eNB 220 checks the packet handling method for the destination IP address is set to GTP-STRIP-FWD or DIRECT-FWD (815). If the packet handling method is set to GTP-STRIP-FWD, the eNB 220 performs GTP decapsulation by removing the GTP head (817), checks the Radio Bearer ID mapped to the destination IP address in the Radio-EPS Bearer ID table (819), and forwards the GTP decapsulated packet to the UE on the designated Radio Bearer channel identified by the Radio Bearer ID (823). At step 819, the Radio Bearer ID can be obtained by looking up the Radio-EPS Bearer ID table for the EPS Bearer ID contained in the GTP header of the packet. If the packet handling method is set to DIRECT-FWD in the downlink radio bearer table, the eNB 220 checks the Radio Bearer ID mapped to the destination IP address in the downlink radio bearer table (821) and forwards the packet on the corresponding Radio Bearer channel (823).

As described above, the local PDN access method of the present invention is capable of reducing the use of the costly backhaul network and traffic load of the core network. Since the local traffic occupies large portion of the entire network traffic, the direct connection of the base station to the local PDN can reduce the traffic load of the core network significantly and routing delay of the local traffic, resulting in improvement of the service quality.

Also, the local PDN access method of the present invention is capable of routing the local traffic at private base station level, resulting in reduction of communication costs. With the reduction of the communication costs, the local PDN access method of the present invention promotes the use of the data service.

Also, the local PDN access method of the present invention is advantageous to introduce new business models from the view point of the service providers. For instance, the WiFi networks as the dominant enterprise networks can be substituted by the PDN networks of the LTE system. In this case, the members of the enterprise can access the PDN in and out of the network in the same manner. The members can access the enterprise server by means of a single mobile terminal such as a laptop anywhere and maintain the connections among the members always, resulting in improvement of productivity. Also, the PDN access method of the present invention can be applied for interconnection between the femto base station and indoor network. In this case, the user can cheaply connect the desktop computer and mobile devices with each other and access the desktop computer to upload and download data even on a travel.

Although exemplary embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. A local Packet Data Network (PDN) access method in a wireless communication system, comprising: transmitting a local PDN connectivity request message from a base station to a Mobility Management Entity (MME); transmitting a bearer request message from the MME received the PDN connectivity request message to a Serving Gateway (SGW) proxy of the base station; forwarding the bearer request message from the SGW proxy to a PDN Gateway (PGW) proxy of the base station; transmitting a bearer response message indicating a local PDN access service of the base station in gateway mode from the PGW proxy to the SGW proxy; forwarding the bearer response message from the SGW to the MME; transmitting a bearer setup message from the MME received the bearer response message to the base station; and—connecting a mobile terminal to the local PDN based on information contained in the bearer setup message.

2. The local PDN access method of claim 1, wherein the bearer response message comprises an Internet Protocol (IP) address assigned for use in the local PDN.

3. The local PDN access method of claim 2, wherein the bearer response message comprises an Evolved Packet System (EPS) bearer identifier (EPS bearer ID) for direct forwarding and a General Packet Radio Service Tunneling Protocol (GTP) tunnel ID for use in gateway mode.

4. The local PDN access method of claim 3, wherein transmitting a bearer setup message comprising generating the bearer setup message including the GTP tunnel ID informing of the base station as a gateway and the EPS bearer ID informing of a bearer allocated for use in the local PDN.

5. The local PDN access method of claim 4, wherein connecting a mobile terminal to the local PDN comprises routing a packet call from the mobile terminal to the local PDN based on information included in the bearer setup message.

6. A local Packet Data Network (PDN) access method in a wireless communication system, comprising: transmitting a local PDN connectivity request message from a base station to a Mobility Management Entity (MME); transmitting a bearer request message from the MME received the PDN connectivity request message to a Serving Gateway (SGW) proxy of the base station; forwarding the bearer request message from the SGW proxy to a PDN Gateway (PGW) of the local PDN; transmitting a bearer response message permitting an access to the local PDN from the PGW to the SGW proxy in response to the bearer request message; forwarding the bearer response message from the SGW proxy to the MME; transmitting a bearer setup message from the MME received the bearer response message to the base station; and connecting a mobile terminal to the to the local PDN base on information contained in the bearer setup message.

7. A base station of a wireless communication system supporting a local Packet Data Network (PDN) access service for delivering a packet call of a mobile terminal, comprising: a terminal interface module which provides an interface with the mobile terminal; a Serving Gateway (SGW) proxy which emulates a gateway function of a SGW and processes an S11 interface with a Mobility Management Entity (MME); a PDN Gateway (PGW) proxy which allocates an Internet Protocol (IP) address for the mobile terminal to access the local PDN and emulates a gateway function of a PGW; a General Packet Radio Service Tunneling Protocol (GTP) module which provides a S1 interface between the base station and the SGW and a packet interface between the base station and the PDN and forwards a packet call of the mobile terminal directly in gateway mode; an IP routing module which routes the packet call forwarded by the GTP module to the local PDN; and a base station controller which analyzes a message transmitted by the MME and controls routing the packet call to the local PDN based on the analysis result in gateway mode.

8. A wireless communication system supporting a local Packet Data Network (PDN) access of a mobile terminal, comprising: a local PDN including a PDN Gateway (PGW); and a base station which establishes a packet call of a mobile terminal with the local PDN, wherein the base station comprises: a terminal interface module which provides an interface with the mobile terminal; a Serving Gateway (SGW) proxy which emulates a gateway function of a SGW and processes an S11 interface with a Mobility Management Entity (MME); a PDN Gateway (PGW) proxy which allocates an Internet Protocol (IP) address for the mobile terminal to access the local PDN and emulates a gateway function of a PGW; a General Packet Radio Service Tunneling Protocol (GTP) module which provides a S1 interface between the base station and the SGW and a packet interface between the base station and the PDN and forwards a packet call of the mobile terminal directly in gateway mode; an IP routing module which routes the packet call forwarded by the GTP module to the local PDN; and a base station controller which analyzes a message transmitted by the MME and controls routing the packet call to the local PDN based on the analysis result in gateway mode.
